(19) United States
(12) Patent Application Publication
(10) Pub. No.: US 2025/0261058 A1
(43) Pub. Date: Aug. 14, 2025

(54) CONFIGURATION METHOD FOR MOBILITY MANAGEMENT, AND APPARATUS

(71) Applicant: BEIJING XIAOMI MOBILE SOFTWARE CO., LTD., Beijing (CN)

(72) Inventors: Yumin WU, Beijing (CN); Yi XIONG, Beijing (CN)

(73) Assignee: BEIJING XIAOMI MOBILE SOFTWARE CO., LTD., Beijing (CN)

(21) Appl. No.: 18/857,091

(22) PCT Filed: Apr. 22, 2022
(86) PCT No.: PCT/CN2022/088632

§ 371 Date: Oct. 15, 2024

(51) Int. Cl. H04W 36/00

(52) U.S. Cl. CPC H04W 36/00837

(57) ABSTRACT

A method for configuring mobility management includes: sending configuration information of condition-triggered cell management and a type of the condition-triggered cell management to a terminal device.

### CROSS-REFERENCE TO RELATED APPLICATIONS

The present application is a U.S. National Phase of International Application No. PCT/CN2022/088632, filed with the State Intellectual Property Office of P. R. China on Apr. 22, 2022, the content of which is incorporated herein by reference in its entirety for all purposes.

### TECHNICAL FIELD

The disclosure relates to a field of communication technology, in particular to a method for configuring mobility management and an apparatus.

### BACKGROUND

In the 5th generation mobile communication technology (5G) system, a terminal device can perform mobility management based on a “preconfigured condition” of a network and a “preconfigured cell” corresponding to the condition. When the terminal device satisfies the “preconfigured condition”, e.g., when the terminal device satisfies a certain measurement event, the terminal device may change a serving cell to the “preconfigured cell”. Generally, this condition-triggered mobility process includes conditional handover (CHO), conditional primary secondary cell (PSCell) addition (CPA) and conditional PSCell change (CPC).

In the current system, it is impossible to configure both the CHO and the CPA (or CPC) for a terminal device supporting dual connectivity (DC), such that the terminal device is unable to improve the reliability of a master cell group (MCG) mobility process and the reliability of a secondary cell group (SCG) mobility process simultaneously.

### SUMMARY

According to a first aspect of embodiments of the disclosure, a method for configuring mobility management, performed by a network device, is provided. The method includes;
sending configuration information of condition-triggered cell management and a type of the condition-triggered cell management to a terminal device.

According to a second aspect of embodiments of the disclosure, a method for configuring mobility management, performed by a terminal device, is provided. The method includes:
receiving configuration information of condition-triggered cell management and a type of the condition-triggered cell management sent by a network device.

According to a third aspect of embodiments of the disclosure, a communication apparatus is provided. The communication apparatus includes: a processor and a memory having a computer program stored thereon. The processor executes the computer program stored in the memory, to cause the communication apparatus to perform the method described in the first aspect above.

According to a fourth aspect of embodiments of the disclosure, a communication apparatus is provided. The communication apparatus includes: a processor and a memory having a computer program stored thereon. The processor executes the computer program stored in the memory, to cause the communication apparatus to perform the method described in the second aspect above.

According to a fifth aspect of embodiments of the disclosure, a non-transitory computer-readable storage medium is provided. The computer-readable storage medium is configured to store instructions used by the above network device. When the instructions are executed, the terminal device is caused to perform the method of the above first aspect.

### BRIEF DESCRIPTION OF THE DRAWINGS

In order to clearly illustrate technical solutions of embodiments of the disclosure or background technologies, a description of drawings used in the embodiments of the disclosure or the background technologies is given below.

FIG. 1 is a schematic diagram of a communication system provided by an embodiment of the disclosure.

FIG. 2 is a flowchart of a method for configuring mobility management according to an embodiment of the disclosure.

FIG. 3 is a flowchart of a method for configuring mobility management according to an embodiment of the disclosure.

FIG. 4 is a flowchart of a method for configuring mobility management according to an embodiment of the disclosure.

FIG. 5 is a flowchart of a method for configuring mobility management according to an embodiment of the disclosure.

FIG. 6 is a schematic diagram of a communication apparatus according to an embodiment of the disclosure.

FIG. 7 is a schematic diagram of another communication apparatus according to an embodiment of the disclosure.

FIG. 8 is a schematic diagram of a chip according to an embodiment of the disclosure.

### DETAILED DESCRIPTION

For ease of understanding, terms involved in the disclosure are first introduced.

### 1. Dual Connectivity (DC) Terminal Device

A DC terminal device may access two cell groups, namely, master cell group (MCG) and secondary cell group (SCG). The MCG corresponds to a master node (MN) on a network side, and the SCG corresponds to a secondary node (SN) on the network side.

### 2. Primary Cell (PCell)

Under the MCG, there may be many cells, in which one of the cells is configured to initiate initial access. This cell is called a PCell. As the name suggests, the PCell is the most “primary” cell in the MCG.

### 3. Secondary Cell (SCell)

A secondary cell in the MCG is a SCell. The PCell under the MCG and the SCell under the MCG are connected through carrier aggregation (CA). The MCG includes one or more SCells.

### 4. Primary Secondary Cell (PSCell)

The primary secondary cell in the SCG is a PSCell. The SCG includes one or more SCells.

### 5. Conditional Handover (CHO).

A terminal device may select a target network device according to a pre-configured condition and initiate a handover executing process to initiate random access to the target network device. The terminal device may realize a mobility of MCG by executing the CHO.

### 6. Conditional PSCell Addition (CPA)

A terminal device may determine the PSCell that may be added according to a pre-configured condition. The terminal device may realize a mobility of SCG by executing the CPA.

### 7. Conditional PSCell Change (CPC)

A terminal device may determine the PSCell that may be changed according to a pre-configured condition. The terminal device may realize a mobility of SCG by executing the CPC.

In order to better understand a method of configuring mobility management disclosed by the embodiments of the disclosure, a communication system to which the embodiments of the disclosure are applied is first described below.

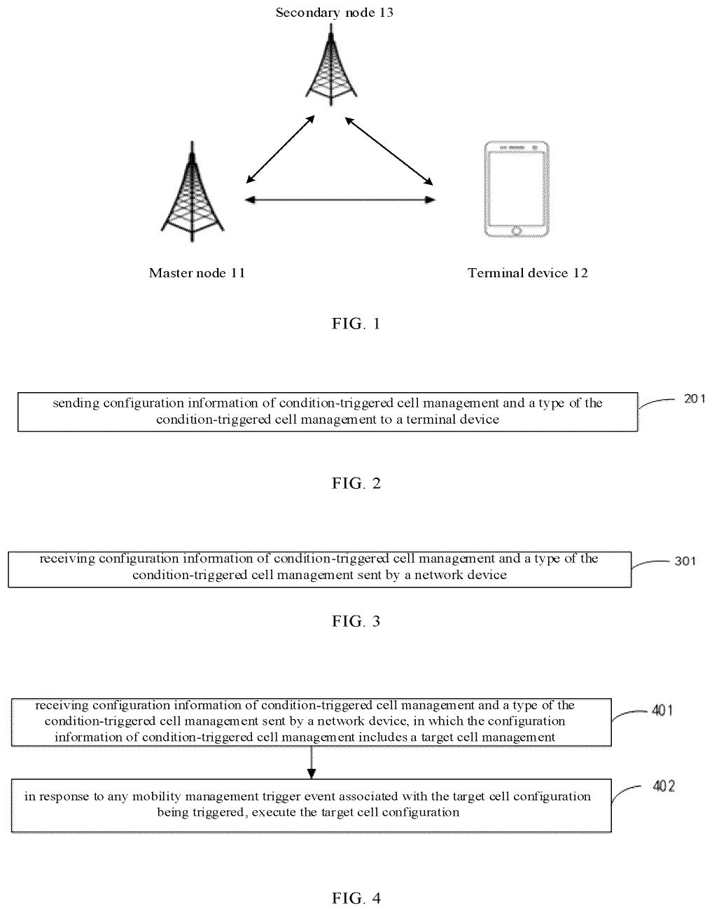

As illustrated in FIG. 1, FIG. 1 is a schematic diagram of a communication system provided by an embodiment of the disclosure. The communication system may include, but is not limited to, a network device and a terminal device. The number and the form of devices illustrated in FIG. 1 are only for examples and do not constitute a limitation on the embodiments of the disclosure, and two or more network devices, two or more auxiliary communication devices, and two or more terminal devices may be included in practical applications. For example, the communication system shown in FIG. 1 includes a MN device 11, a terminal device 12, and a SN device 13.

It is noteworthy that the technical solutions of the embodiments of the disclosure may be applied to various communication systems, such as, a long term evolution (LTE) system, a 5th generation (5G) mobile communication system, a 5G new radio (NR) system, or other future new mobile communication systems.

The MN 11 and the SN 13 in the embodiments of the disclosure are entities on a network side for transmitting or receiving signals, which may be a MN and a SN corresponding to the terminal device 12, respectively. For example, the MN 11 and the SN 13 may be an evolved NodeB (eNB), a transmission reception point (TRP), a next generation NodeB (gNB) in a NR system, a base station in other future mobile communication systems, or an access node in a wireless fidelity (WiFi) system, respectively. The specific technology and specific device form adopted by the network device are not limited in the embodiments of the disclosure. The network device according to the embodiments of the disclosure may be composed of a central unit (CU) and a distributed unit (DU). The CU may also be called a control unit. The use of CU-DU structure allows to divide a protocol layer of the network device, such as a base station, such that some functions of the protocol layer are placed in the CU for centralized control, and some or all of the remaining functions of the protocol layer are distributed in the DU, and the DU is centrally controlled by the CU.

The terminal device 12 in the embodiments of the disclosure is an entity on a user side for receiving or transmitting signals, such as a cellular phone. The terminal device may also be referred to as a terminal, a user equipment (UE), a mobile station (MS), a mobile terminal (MT), and the like. The terminal device may be a car with communication functions, a smart car, a mobile phone, a wearable device, a Pad, a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The specific technology and specific device form adopted by the terminal device are not limited in the embodiments of the disclosure.

It is understandable that the communication system described in the embodiments of the disclosure is intended to clearly illustrate the technical solutions of the embodiments of the disclosure, and does not constitute a limitation on the technical solutions of the embodiments of the disclosure. It is understandable by those skilled in the art that as system architectures evolve and new business scenarios emerge, the technical solutions according to the embodiments of the disclosure are also applicable to similar technical problems.

In the disclosure, in order to improve the reliability of an MCG mobility process and the reliability of an SCG mobility process of a DC terminal device at the same time, the terminal device may be provided with both of MCG mobility management configuration and/or SCG mobility management configuration, such that the terminal device may trigger CHO and/or CPA, or trigger CHO and/or CPC according to the scenarios, thereby improving the reliabilities of the MCG mobility process and the SCG mobility process.

It is noted that in the disclosure, a method for processing conditional reconfiguring configuration information provided by any one of the embodiments may be performed alone, or may be performed in combination with possible implementations in other embodiments, or may be performed in combination with any one of the technical solutions in the related arts.

As illustrated in FIG. 2, FIG. 2 is a flowchart of a method for configuring mobility management according to an embodiment of the disclosure. The method is performed by a network device. As illustrated in FIG. 2, the method includes but is not limited to the following steps.

At step 201, configuration information of condition-triggered cell management and a type of the condition-triggered cell management is sent to a terminal device.

Optionally, the configuration information of the condition-triggered cell management may include at least one of the following: a mobility management trigger event, a target cell configuration, or an association relation between the mobility management trigger event and the target cell configuration.

The mobility management trigger event may be any trigger event that satisfies a certain measurement result, for example, an reference signal received power (RSRP) of a target cell exceeds a threshold value.

Optionally, the mobility management trigger event includes at least one of: a trigger event for MCG mobility management; a trigger event for SCG mobility management; a trigger event for MCG and SCG mobility management; a trigger event for MCG mobility management, and MCG and SCG mobility management; a trigger event for SCG mobility management, and MCG and SCG mobility management; or a trigger event for MCG mobility management, SCG mobility management, and MCG and SCG mobility management.

The trigger event for MCG and SCG mobility management includes any one of; a trigger event for assessing an MCG mobility assessment; a trigger event for assessing an SCG mobility; or a plurality of trigger events for assessing an MCG mobility and for assessing an SCG mobility, respectively.

That is, the trigger event may be configured only for assessing an MCG mobility assessment, but does not include an assessment for measurement results of cells in the SCG, or the trigger event may be configured only for assessing an SCG mobility assessment, but does not include an assessment for measurement results of cells in the MCG; or the trigger event may include a plurality of events, including a trigger event for assessing the MCG mobility and a trigger event for assessing the SCG mobility.

There are one or more mobility management trigger events associated with the target cell configuration.

Optionally, if the trigger event for MCG and SCG mobility management includes a plurality of trigger events for assessing the MCG mobility and for assessing the SCG mobility, respectively, the terminal device may apply the target cell configuration when all the plurality of trigger events are met, or when any of the plurality of trigger events is met, which is not limited in the disclosure.

The trigger event for MCG mobility management, and MCG and SCG mobility management refers to that the trigger event may be configured to trigger the MCG mobility management, or may also be configured for a triggering judgment of the MCG in the MCG and SCG mobility management. For example, the trigger event for MCG handover is A1, and the trigger event for SCG change or addition is A2, when the trigger event A1 for MCG handover and the trigger event A2 for SCG change or addition are met at the same time, the trigger event A1+A2 may be configured to trigger the MCG mobility management and the SCG mobility management at the same time.

Correspondingly, the trigger event for SCG mobility management and MCG and SCG mobility management refers to that the trigger event may be configured to trigger the SCG mobility management, or, may also be configured for a triggering judgment of the SCG in the MCG and SCG mobility management. For example, the trigger event for SCG change or addition is A3, and the trigger event for MCG handover is A4, when the trigger event A3 for SCG change or addition and the trigger event A4 for MCG handover are met at the same time, the trigger event A3+A4 may be configured to trigger the MCG mobility management and the SCG mobility management at the same time.

In addition, the trigger event for MCG mobility management, SCG mobility management, and MCG and SCG mobility management refers to that the trigger event may be configured to trigger the MCG mobility management, or may also trigger the SCG mobility management, or may also be configured for the triggering judgment of the SCG in the MCG and SCG mobility management. For example, a trigger event A5 may be configured to trigger SCG change/addition, or trigger MCG handover, the trigger event A1 may be configured to trigger the MCG handover, and the trigger event A3 may be configured to trigger the SCG change or addition, when the trigger event A5 and the trigger event A1 are met at the same time, they may be configured to trigger the MCG mobility management and the SCG mobility management at the same time. However, when the trigger event A5 and the trigger event A3 are met at the same time, the trigger event A3+A5 may be configured to trigger the MCG mobility management and the SCG mobility management at the same time.

Optionally, the target cell configuration includes at least one of the following: target cell configuration information for MCG mobility management; target cell configuration information for SCG mobility management; target cell configuration information for MCG and SCG mobility management; target cell configuration information for MCG mobility management, and MCG and SCG mobility management; target cell configuration information for SCG mobility management, and MCG and SCG mobility management; or target cell configuration information for MCG mobility management, SCG mobility management, and MCG and SCG mobility management.

The target cell configuration information for MCG and SCG mobility management refers to that the target cell configuration information is configured for the MCG and SCG mobility management. The target cell configuration information for MCG mobility management, and MCG and SCG mobility management refers to that the target cell configuration information may be configured for both of the MCG mobility management and the MCG and SCG mobility management, Correspondingly, the target cell configuration information for MCG mobility management, SCG mobility management, and MCG and SCG mobility management refers to that the target cell configuration information may be configured for the MCG mobility management, the SCG mobility management, and the MCG and SCG mobility management.

For example, if the configuration information of the condition-triggered cell management includes: the trigger event for assessing the MCG mobility, and the target cell configuration information for the MCG mobility management, the terminal device may execute the corresponding target cell configuration information of the MCG mobility management after the trigger event is met.

Alternatively, if the configuration information of the condition-triggered cell management includes the target cell configuration information for MCG mobility management, SCG mobility management, and MCG and SCG mobility management, the terminal device executes the target cell configuration information when it is determined that the execution condition of CHO is met, or executes the target cell configuration information when it is determined that the execution conditions of CHO and CPC (or CPA) are met, or executes the target cell configuration information when it is determined that the execution condition of CPA is met.

Optionally, the network device may configure the target cell configuration information for MCG mobility management and the target cell configuration information for SCG mobility management for the terminal device through one message. For example, the target cell configuration information for MCG mobility management and the target cell configuration information for SCG mobility management are contained in an radio resource control (RRC) reconfiguration message for configuring both of the MCG and the SCG.

Alternatively, the target cell configuration information for MCG mobility management and the target cell configuration information for SCG mobility management may be separately configured for the terminal device through different messages. For example, the target cell configuration information for MCG mobility management may be contained in an RRC reconfiguration message for configuring the MCG, while the target cell configuration information for SCG mobility management may be contained in an RRC reconfiguration message for configuring the SCG.

That is, the target cell configuration information for MCG mobility management and the target cell configuration information for SCG mobility management are contained respectively in different messages, or, the target cell configuration information for MCG mobility management and the target cell configuration information for SCG mobility management are contained in the same message.

Optionally, the target cell configuration may also include a mobility management trigger event or configuration information of condition-triggered cell management.

For example, the RRC reconfiguration message for configuring the target cell configuration information for the terminal device may include a mobility management trigger event configuration. The mobility management trigger event configuration may be configured only for the trigger event for the SCG mobility management, or only for the trigger event for the MCG mobility management, or for the trigger event for both of the MCG mobility management and the SCG mobility management, which is not limited in the disclosure. Alternatively, the RRC reconfiguration message for configuring the target cell configuration information for the terminal device may include the configuration information of the condition-triggered cell management. The configuration information of the condition-triggered cell management may be configuration information of condition-triggered cell management configured only for the SCG mobility management, such as CPA or CPC configuration, or, configuration information of condition-triggered cell management configured only for the MCG mobility management, such as CHO, or, configuration information of condition-triggered cell management configured for both of the MCG mobility management and the SCG mobility management, such as CHO and CPC (or CPA), which is not limited in the disclosure.

In addition, when the network device configures the configuration information of the condition-triggered cell management for the terminal device, the network device may also indicate the type of the configuration information, so that the terminal device may distinguish types of the configuration information of the different condition-triggered cell management and execute the target cell configuration corresponding to the current trigger type.

Optionally, the type of the condition-triggered cell management includes at least one of the following: MCG mobility management; SCG mobility management; MCG and SCG mobility management; MCG mobility management, and MCG and SCG mobility management; SCG mobility management, and MCG and SCG mobility management; or MCG mobility management, SCG mobility management, and MCG and SCG mobility management.

The MCG and SCG mobility management refers to that the type of the cell management is the MCG and SCG mobility management. The MCG mobility management, and MCG and SCG mobility management refer that the type of the cell management is the MCG mobility management or the MCG and SCG mobility management. The MCG mobility management, SCG mobility management, and MCG and SCG mobility management refer to that the type of the cell management is the MCG mobility management, or the SCG mobility management, or the MCG and SCG mobility management.

In the disclosure, the network device sends the configuration information of the condition-triggered cell management and the type of the condition-triggered cell management to the terminal device. Therefore, by configuring a MCG mobility management configuration and/or a SCG mobility management configuration for the terminal device, the terminal device may trigger CHO and/or CPA, or trigger CHO and/or CPC according to a triggering situation of a triggering condition, thereby improving the reliabilities of the MCG mobility process and the SCG mobility process.

As illustrated in FIG. 3, FIG. 3 is a flowchart of a method for configuring mobility management according to an embodiment of the disclosure. The method is performed by a terminal device. As illustrated in FIG. 3, the method includes but is not limited to the following steps.

At step 301, configuration information of condition-triggered cell management and a type of the condition-triggered cell management sent by a network device is received.

Optionally, the configuration information of the condition-triggered cell management may include at least one of the following: a mobility management trigger event, a target cell configuration, or an association relation between the mobility management trigger event and the target cell configuration.

The mobility management trigger event may be any trigger event that satisfies a certain measurement result, for example, an RSRP of a target cell exceeds a threshold value.

Optionally, the mobility management trigger event may include at least one of the following: a trigger event for MCG mobility management; a trigger event for SCG mobility management; a trigger event for MCG and SCG mobility management; a trigger event for MCG mobility management, and MCG and SCG mobility management; a trigger event for SCG mobility management, and MCG and SCG mobility management; or a trigger event for MCG mobility management, SCG mobility management, and MCG and SCG mobility management.

The trigger event for MCG and SCG mobility management includes any one of: a trigger event for assessing an MCG mobility, a trigger event for assessing an SCG mobility, or a plurality of trigger events for assessing an MCG mobility and for assessing an SCG mobility, respectively.

That is, the trigger event may be configured only for assessing an MCG mobility assessment, but does not include an assessment for measurement results of cells in the SCG, or the trigger event may be configured only for assessing an SCG mobility assessment, but does not include an assessment for measurement results of cells in the MCG; or the trigger event may include a plurality of events, including a trigger event for assessing the MCG mobility and a trigger event for assessing the SCG mobility.

There are one or more mobility management trigger events associated with the target cell configuration.

Optionally, if the trigger event for MCG and SCG mobility management includes a plurality of trigger events for assessing the MCG mobility and for assessing the SCG mobility, respectively, the terminal device may apply the target cell configuration when all the plurality of trigger events are met, or may apply the target cell configuration when any one of the plurality of trigger events is met, which is not limited in the disclosure.

In addition, the trigger event for MCG mobility management, and MCG and SCG mobility management refers to that the trigger event may be configured to trigger the MCG mobility management, or may also be configured for a triggering judgment of the MCG in the MCG and SCG mobility management. For example, the trigger event for MCG handover is A1, and the trigger event for SCG change or addition is A2, when the trigger event A1 for MCG handover and the trigger event A2 for SCG change or addition are met at the same time, the trigger event A1+A2 may be configured trigger the MCG mobility management and SCG mobility management at the same time.

Correspondingly, the trigger event for SCG mobility management, and MCG and SCG mobility management refers to that the trigger event may be configured to trigger the SCG mobility management, or, can may also be configured for a triggering judgment of the SCG in the MCG and SCG mobility management. For example, the trigger event for SCG change or addition is A3, and the trigger event for MCG handover is A4, when the trigger event A3 for SCG change or addition and the trigger event A4 for MCG handover are met at the same time, the trigger event A3+A4 may be configured to trigger the MCG mobility management and the SCG mobility management at the same time.

In addition, the trigger event for MCG mobility management, SCG mobility management, and MCG and SCG mobility management refers to that the trigger event may be configured to trigger the MCG mobility management, or may also trigger the SCG mobility management, or may also be configured for the triggering judgment of the SCG in the MCG and SCG mobility management. For example, a trigger event A5 may be configured to trigger SCG change/addition, or trigger MCG handover, the trigger event A1 may be configured to trigger the MCG handover, and the trigger event A3 may be configured to trigger the SCG change or addition, when the trigger event A5 and the trigger event A1 are met at the same time, they may be configured to trigger the MCG mobility management and the SCG mobility management at the same time. However, when the trigger event A5 and the trigger event A3 are met at the same time, the trigger event A3+A5 may be configured to trigger the MCG mobility management and the SCG mobility management at the same time.

Optionally, the target cell configuration includes at least one of the following: target cell configuration information for MCG mobility management; target cell configuration information for SCG mobility management; target cell configuration information for MCG and SCG mobility management; target cell configuration information for MCG mobility management, and MCG and SCG mobility management; target cell configuration information for SCG mobility management, and MCG and SCG mobility management; or target cell configuration information for MCG mobility management, SCG mobility management, and MCG and SCG mobility management.

The target cell configuration information for MCG and SCG mobility management refers to that the target cell configuration information is configured for the MCG and SCG mobility management. The target cell configuration information for MCG mobility management, and MCG and SCG mobility management refers to that the target cell configuration information may be configured for both of the MCG mobility management and the MCG and SCG mobility management. Correspondingly, the target cell configuration information for MCG mobility management, SCG mobility management, and MCG and SCG mobility management refers to that the target cell configuration information may be configured for the MCG mobility management, the SCG mobility management, and the MCG and SCG mobility management.

For example, if the configuration information of the condition-triggered cell management includes: the trigger event for assessing the MCG mobility, and the target cell configuration information for the MCG mobility management, the terminal device may execute the corresponding target cell configuration information of the MCG mobility management after the trigger event is met.

Alternatively, if the configuration information of condition-triggered cell management includes the target cell configuration information for MCG mobility management, SCG mobility management, and MCG and SCG mobility management, the terminal device executes the target cell configuration information when it is determined that the execution condition of CHO is met, or executes the target cell configuration information when it is determined that the execution conditions of CHO and CPC (or CPA) are met, or executes the target cell configuration information when it is determined that the execution condition of CPA is met.

Optionally, the network device may configure the target cell configuration information for MCG mobility management and the target cell configuration information for SCG mobility management for the terminal device through one message. For example, the target cell configuration information for MCG mobility management and the target cell configuration information for SCG mobility management are contained in an RRC reconfiguration message for configuring both of the MCG and the SCG.

Alternatively, the target cell configuration information for MCG mobility management and the target cell configuration information for SCG mobility management may be separately configured for the terminal device through different messages. For example, the target cell configuration information for MCG mobility management may be contained in an RRC reconfiguration message for configuring the MCG, while the target cell configuration information for SCG mobility management may be contained in an RRC reconfiguration message for configuring the SCG.

That is, the target cell configuration information for MCG mobility management and the target cell configuration information for SCG mobility management are contained respectively in different messages, or, the target cell configuration information for MCG mobility management and the target cell configuration information for SCG mobility management are contained in the same message.

Optionally, the target cell configuration may also include a mobility management trigger event or configuration information of condition-triggered cell management.

For example, the RRC reconfiguration message for configuring the target cell configuration information for the terminal device may include a mobility management trigger event configuration. The mobility management trigger event configuration may be configured only for the trigger event for the SCG mobility management, or only for the trigger event for the MCG mobility management, or for the trigger event for both of the MCG mobility management and the SCG mobility management, which is not limited in the disclosure. Alternatively, the RRC reconfiguration message for configuring the target cell configuration information for the terminal device may include the configuration information of the condition-triggered cell management. The configuration information of the condition-triggered cell management may be configuration information of condition-triggered cell management configured only for the SCG mobility management, such as CPA or CPC configuration, or, configuration information of condition-triggered cell management configured only for the MCG mobility management, such as CHO, or, configuration information of condition-triggered cell management configured for both of the MCG mobility management and the SCG mobility management, such as CHO and CPC (or CPA), which is not limited in the disclosure.

In addition, when the network device configures the configuration information of the condition-triggered cell management for the terminal device, the network device may also indicate the type of the configuration information, so that the terminal device may distinguish types of the configuration information of the different condition-triggered cell management and execute the target cell configuration corresponding to the current trigger type.

Optionally, the type of the condition-triggered cell management includes at least one of the following: MCG mobility management; SCG mobility management; MCG and SCG mobility management; MCG mobility management, and MCG and SCG mobility management; SCG mobility management, and MCG and SCG mobility management; or MCG mobility management, SCG mobility management, and MCG and SCG mobility management.

The MCG and SCG mobility management refers to that the type of the cell management is the MCG and SCG mobility management. The MCG mobility management, and MCG and SCG mobility management refer that the type of the cell management is the MCG mobility management or the MCG and SCG mobility management. The MCG mobility management, SCG mobility management, and MCG and SCG mobility management refer to that the ctype of the cell management is the MCG mobility management, or the SCG mobility management, or the MCG and SCG mobility management.

In the disclosure, after configuring a MCG mobility management configuration and/or a SCG mobility management configuration for the terminal device, the terminal device may trigger CHO and/or CPA, or trigger CHO and/or CPC according to a triggering situation of a triggering condition, thereby improving the reliabilities of the MCG mobility process and the SCG mobility process.

As illustrated in FIG. 4, FIG. 4 is a flowchart of a method for configuring mobility management provided by an embodiment of the disclosure. The method is performed by a terminal device. As illustrated in FIG. 4, the method includes but is not limited to the following steps.

At step 401, configuration information of condition-triggered cell management and a type of the condition-triggered cell management sent by a network device is received, in which the configuration information of the condition-triggered cell management includes a target cell configuration.

Optionally, the configuration information of condition-triggered cell management may also include a mobility management trigger event, or an association relation between the mobility management trigger event and the target cell configuration. Alternatively, the target cell configuration may include a mobility management trigger event, which is not limited in the disclosure.

There may be one or more mobility management trigger conditions associated with the target cell configuration. The plurality of mobility management trigger conditions may be a plurality of trigger events for assessing an MCG mobility and for assessing an SCG mobility, respectively.

The specific implementation of the above step 401 can be described in detail with reference to any of the embodiments of the disclosure and will not be repeated herein.

At step 402, in response to any mobility management trigger event associated with the target cell configuration being triggered, the target cell configuration is executed.

Optionally, if there is only one mobility management trigger condition associated with the target cell configuration, the terminal device may execute the target cell configuration when that trigger condition is triggered.

Optionally, if there are a plurality of mobility management trigger conditions associated with the target cell configuration, the terminal device may execute the target cell configuration when any one of the mobility management trigger events is triggered.

In the disclosure, after configuring the target cell configuration for MCG mobility management and/or SCG mobility management for the terminal device, the terminal device can execute the corresponding target cell configuration when any of the trigger conditions is triggered, thereby improving the reliabilities of the MCG mobility process and the SCG mobility process.

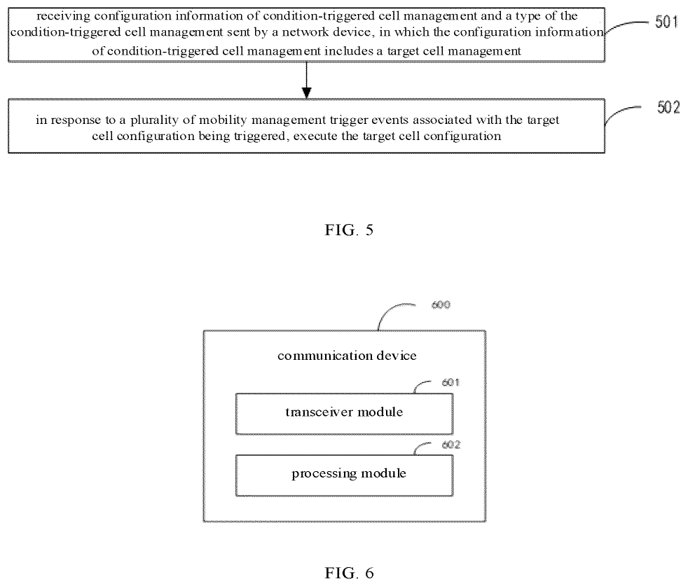

As illustrated in FIG. 5, FIG. 5 is a flowchart of a method for configuring mobility management provided by an embodiment of the disclosure. The method is performed by a terminal device. As illustrated in FIG. 5, the method includes but is not limited to the following steps.

At step 501, configuration information of condition-triggered cell management and a type of the condition-triggered cell management sent by a network device is received, in which the configuration information of the condition-triggered cell management includes a target cell configuration.

Optionally, the configuration information of condition-triggered cell management may also include a mobility management trigger event, or an association relation between the mobility management trigger event and the target cell configuration. Alternatively, the target cell configuration may include a mobility management trigger event, which is not limited in the disclosure.

The specific implementation of the above step 501 can be described in detail with reference to any of the embodiments of the disclosure and will not be repeated herein.

At step 502, in response to a plurality of mobility management trigger events associated with the target cell configuration being triggered, the target cell configuration is executed.

In the disclosure, after configuring the target cell configuration for MCG mobility management and/or SCG mobility management for the terminal device, the terminal device can execute the corresponding target cell configuration when the trigger conditions associated with the target cell configuration are triggered, thereby improving the reliabilities of the MCG mobility process and the SCG mobility process.

As illustrated in FIG. 6, FIG. 6 is a schematic diagram of a communication apparatus 600 provided by an embodiment of the disclosure. The communication apparatus 600 shown in FIG. 6 may include a transceiver module 601. The transceiver module 601 may include a transmitting module and/or a receiving module. The transmitting module is configured for realizing a transmitting function, and the receiving module is configured for realizing a receiving function. The transceiver module 601 may realize the transmitting function and/or the receiving function.

It will be appreciated that the communication apparatus 600 may be a network device, an apparatus in the network device, or an apparatus capable of being used together with the network device.

If the communication apparatus 600 is on the network device side, the communication apparatus 600 includes:
a transceiver module 601,
the transceiver module is configured to send configuration information of condition-triggered cell management and a type of the condition-triggered cell management to a terminal device.

Optionally, the type of the condition-triggered cell management includes at least one of:
MCG mobility management;
SCG mobility management;
MCG and SCG mobility management;
MCG mobility management, and MCG and SCG mobility management;
SCG mobility management, and MCG and SCG mobility management; or
MCG mobility management, SCG mobility management, and MCG and SCG mobility management.

Optionally, the configuration information of the condition-triggered cell management includes at least one of:
a mobility management trigger event;
a target cell configuration; or
an association relation between a mobility management trigger event and a target cell configuration.

Optionally, the target cell configuration includes at least one of:
target cell configuration information for MCG mobility management;
target cell configuration information for SCG mobility management;
target cell configuration information for MCG and SCG mobility management;
target cell configuration information for MCG mobility management, and MCG and SCG mobility management;
target cell configuration information for SCG mobility management, and MCG and SCG mobility management; or
target cell configuration information for MCG mobility management, SCG mobility management, and MCG and SCG mobility management.

Optionally, the target cell configuration information for MCG mobility management and the target cell configuration information for SCG mobility management are contained respectively in different messages; or
the target cell configuration information for MCG mobility management and the target cell configuration information for SCG mobility management are contained in the same message.

Optionally, the mobility management trigger event includes at least one of:
a trigger event for MCG mobility management;
a trigger event for SCG mobility management;
a trigger event for MCG and SCG mobility management;
a trigger event for MCG mobility management, and MCG and SCG mobility management;
a trigger event for SCG mobility management, and MCG and SCG mobility management; or
a trigger event for MCG mobility management, SCG mobility management, and MCG and SCG mobility management.

Optionally, the trigger event for MCG and SCG mobility management includes any one of:
a trigger event for assessing an MCG mobility;
a trigger event for assessing an SCG mobility; or
a plurality of trigger events for assessing an MCG mobility and for assessing an SCG mobility assessment, respectively.

Optionally, there are one or more mobility management trigger events associated with the target cell configuration.

In the disclosure, the network device sends the configuration information of condition-triggered cell management and the type of the condition-triggered cell management to the terminal device. Therefore, after configuring MCG mobility management configuration and/or SCG mobility management configuration for the terminal device, the terminal device can trigger CHO and/or CPA, or trigger CHO and/or CPC according to a triggering situation of a triggering condition, thereby improving the reliabilities of the MCG mobility process and the SCG mobility process.

It will be appreciated that the communication apparatus 600 may be a terminal device, an apparatus in the terminal device, or an apparatus capable of being used together with the terminal device.

If the communication apparatus 600 is on the terminal device side, the communication apparatus 600 includes:

a transceiver module 601, configured to receive configuration information of condition-triggered cell management and a type of the condition-triggered cell management sent by a network device.

Optionally, the type of the condition-triggered cell management includes at least one of:
MCG mobility management;
SCG mobility management;
MCG and SCG mobility management;
MCG mobility management, and MCG and SCG mobility management;
SCG mobility management, and MCG and SCG mobility management; or
MCG mobility management, SCG mobility management, and MCG and SCG mobility management.

Optionally, the configuration information of the condition-triggered cell management includes at least one of:
a mobility management trigger event;
a target cell configuration; or
an association relation between a mobility management trigger event and a target cell configuration.

Optionally, the target cell configuration includes at least one of:
target cell configuration information for MCG mobility management;
target cell configuration information for SCG mobility management;
target cell configuration information for MCG and SCG mobility management;
target cell configuration information for MCG mobility management, and MCG and SCG mobility management;
target cell configuration information for SCG mobility management, and MCG and SCG mobility management; or
target cell configuration information for MCG mobility management, SCG mobility management, and MCG and SCG mobility management,
Optionally, the target cell configuration information for MCG mobility management and the target cell configuration information for SCG mobility management are contained respectively in different messages; or
the target cell configuration information for MCG mobility management and the target cell configuration information for SCG mobility management are contained in the same message.

Optionally, the mobility management trigger event includes at least one off
a trigger event for MCG mobility management;

a trigger event for SCG mobility management;
a trigger event for MCG and SCG mobility management;
a trigger event for MCG mobility management, and MCG and SCG mobility management;
a trigger event for SCG mobility management, and MCG and SCG mobility management; or
a trigger event for MCG mobility management, SCG mobility management, and MCG and SCG mobility management.

Optionally, the trigger event for MCG and SCG mobility management includes any one of:
a trigger event for assessing an MCG mobility;
a trigger event for assessing an SCG mobility; or
a plurality of trigger events for assessing an MCG mobility assessment and for assessing an SCG mobility assessment, respectively.

Optionally, there are one or more mobility management trigger events associated with the target cell configuration.

Optionally, the communication apparatus 600 also includes: a processing module 602.

The processing module 602 is configured to; in response to any mobility management trigger event associated with the target cell configuration being triggered, execute the target cell configuration; or
in response to a plurality of mobility management trigger events associated with the target cell configuration being triggered, execute the target cell configuration.

In the disclosure, after the terminal device is configured with MCG mobility management configuration and/or SCG mobility management configuration, the terminal device can trigger the CHO and/or the CPA or trigger the CHO and/or the CPC according to the trigger condition, thereby improving the reliabilities of the MCG mobility process and the SCG mobility process.

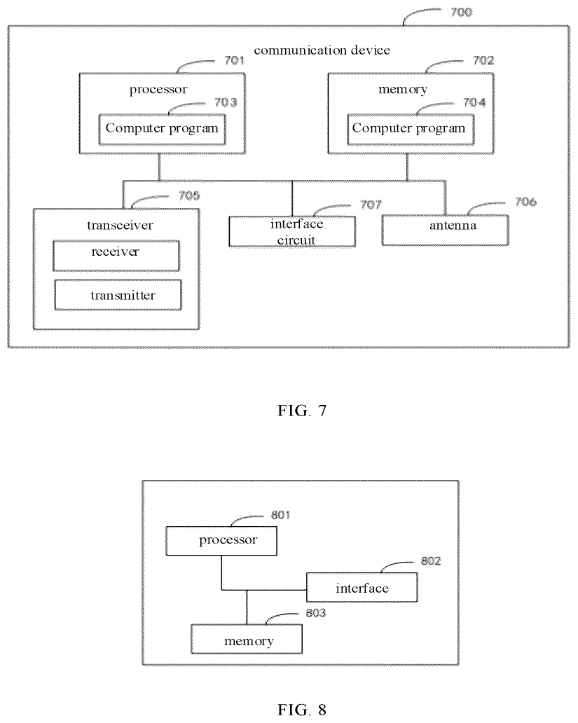

As illustrated in FIG. 7, FIG. 7 is a schematic diagram of a communication apparatus 700 provided by an embodiment of the disclosure. The communication apparatus 700 may be a network device, a communication assisting device, a terminal device, or a chip, a chip system or a processor that supports the network device to realize the above-described methods, or a chip, a chip system or a processor that supports the communication assisting device to realize the above-described methods, or a chip, a chip system or a processor that supports the terminal device to realize the above-described methods. The device may be used to realize the methods described in the above method embodiments with reference to the description of the above-described method embodiments.

The communication apparatus 700 may include one or more processors 701. The processor 701 may be a general purpose processor or a dedicated processor, such as, a baseband processor or a central processor. The baseband processor is used for processing communication protocols and communication data. The central processor is used for controlling the communication apparatus (e.g., base station, baseband chip, terminal device, terminal device chip, DU, or CU), executing computer programs, and processing data of the computer programs.

Optionally, the communication apparatus 700 may include one or more memories 702 on which a computer program 704 may be stored. The processor 701 executes the computer program 703 to cause the communication apparatus 700 to perform the methods described in the above method embodiments. Optionally, the memory may also store data. The communication apparatus 700 and the memory 702 may be provided separately or may be integrated together.

Optionally, the communication apparatus 700 may also include a transceiver 705 and an antenna 706. The transceiver 705 may be referred to as transceiver unit, transceiver machine, or transceiver circuit, for realizing the transceiver function. The transceiver 705 may include a receiver and a transmitter. The receiver may be referred to as receiver machine or receiving circuit, for realizing the receiving function. The transmitter may be referred to as transmitter machine or transmitting circuit, for realizing the transmitting function.

Optionally, the communication apparatus 700 may also include one or more interface circuits 707. The interface circuits 707 are used to receive code instructions and transmit them to the processor 701. The processor 701 runs the code instructions to cause the communication apparatus 700 to perform the methods described in the method embodiments.

If the communication apparatus 700 is a network device, the transceiver 705 performs step 201 in FIG. 2.

If the communication apparatus 700 is a terminal device, the transceiver 705 is used to perform step 301 in FIG. 3, step 401 in FIG. 4, and step 501 in FIG. 5, and the processor 701 is used to perform step 402 in FIG. 4, and step 502 in FIG. 5.

In an implementation, the processor 701 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 701 may store a computer program 703. The computer program 703 runs on the processor 701 and causes the communication apparatus 700 to perform the methods described in the method embodiments above. The computer program 703 may be solidified in the processor 701, in which case the processor 701 may be implemented by hardware.

In an implementation, the communication apparatus 700 may include circuits. The circuits may implement the sending, receiving or communicating function in the preceding method embodiments. The processor and transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the above description of embodiments may be a network device, a terminal device, or a communication assisting device, but the scope of the communication apparatus described in the disclosure is not limited thereto, and the structure of the communication apparatus may not be limited by FIG. 7. The communication apparatus may be a stand-alone device or may be part of a larger device. For example, the communication apparatus may be;
(1) a stand-alone IC, chip, chip system or subsystem;
(2) a collection of ICs including one or more ICs, optionally, the collection of ICs may also include storage components for storing data and computer programs;
(3) an ASIC, such as a modem;
(4) modules that may be embedded within other devices;
(5) receivers, terminal devices, smart terminal devices, cellular phones, wireless devices, handheld machines, mobile units, in-vehicle devices, network devices, cloud devices, artificial intelligence devices, and the like; and
(6) others.

The case where the communication apparatus is a chip or a chip system may be referred to the schematic diagram of a chip shown in FIG. 8. In FIG. 8, the chip includes a processor 801 and an interface 802. There may be one or more processors 801, and there may be multiple interfaces 802.

For the case where the chip is used to implement the functions of the network device in the embodiments of the disclosure,
the interface 802 is configured to executed step 201 in FIG. 2.

For the case where the chip is used to implement the functions of the terminal device in the embodiments of the disclosure,
the interface 802 is configured to execute step 301 in FIG. 3, step 401 in FIG. 4, and step 501 in FIG. 5.

Optionally, the chip further includes a memory 803 used for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that may be understood by the communication apparatus, and the values or representations of the parameters may be other values or representations that may be understood by the communication apparatus. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, define in advance, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

The foregoing are only specific implementations of the disclosure, but the scope of protection of the disclosure is not limited thereto. Any technician skilled in the art can easily think of variations or substitutions within the technical scope disclosed in the disclosure, and the variations or substitutions shall be covered by the scope of protection of the disclosure. Therefore, the scope of protection of the disclosure only be limited by the appended claims.

1. A method for configuring mobility management, performed by a network device, comprising:
sending configuration information of condition-triggered cell management and a type of the condition-triggered cell management to a terminal device.

2. The method of claim 1, wherein the type of the condition-triggered cell management comprises at least one of:
master cell group (MCG) mobility management;
secondary cell group (SCG) mobility management;
MCG and SCG mobility management:
MCG mobility management, and MCG and SCG mobility management;
SCG mobility management, and MCG and SCG mobility management; or
MCG mobility management, SCG mobility management, and MCG and SCG mobility management.

3. The method of claim 1, wherein the configuration information of the condition-triggered cell management comprises at least one of:
a mobility management trigger event;
a target cell configuration; or
an association relation between a mobility management trigger event and a target cell configuration.

4. The method of claim 3, the target cell configuration comprises at least one of:
target cell configuration information for MCG mobility management;
target cell configuration information for SCG mobility management;
target cell configuration information for MCG and SCG mobility management;
target cell configuration information for MCG mobility management, and MCG and SCG mobility management;
target cell configuration information for SCG mobility management, and MCG and SCG mobility management; or
target cell configuration information for MCG mobility management, SCG mobility management, and MCG and SCG mobility management.

5. The method of claim 4, wherein
the target cell configuration information for MCG mobility management and the target cell configuration information for SCG mobility management are contained respectively in different messages; or
the target cell configuration information for MCG mobility management and the target cell configuration information for SCG mobility management are contained in the same message.

6. The method of claim 3, wherein the mobility management trigger event comprises at least one of:
a trigger event for MCG mobility management;
a trigger event for SCG mobility management;
a trigger event for MCG and SCG mobility management;
a trigger event for MCG mobility management, and MCG and SCG mobility management;
a trigger event for SCG mobility management, and MCG and SCG mobility management; or
a trigger event for MCG mobility management, SCG mobility management, and MCG and SCG mobility management.

7. The method of claim 6, wherein the trigger event for MCG and SCG mobility management comprises any one of:
a trigger event for assessing an MCG mobility;
a trigger event for assessing an SCG mobility; or
a plurality of trigger events for assessing an MCG mobility and for assessing an SCG mobility assessment, respectively.

8. The method of claim 3, wherein there are one or more mobility management trigger events associated with the target cell configuration.

9. A method for configuring mobility management, performed by a terminal device, comprising:
receiving configuration information of condition-triggered cell management and a type of the condition-triggered cell management sent by a network device.

10. The method of claim 9, wherein the type of the condition-triggered cell management comprises at least one of:
master cell group (MCG) mobility management;
secondary cell group (SCG) mobility management;
MCG and SCG mobility management;
MCG mobility management, and MCG and SCG mobility management;
SCG mobility management, and MCG and SCG mobility management; or
MCG mobility management, SCG mobility management, and MCG and SCG mobility management.

11. The method of claim 9, wherein the configuration information of the condition-triggered cell management comprises at least one of:
a mobility management trigger event;
a target cell configuration; or
an association relation between a mobility management trigger event and a target cell configuration.

12. The method of claim 11, wherein the target cell configuration comprises at least one of:
target cell configuration information for MCG mobility management;
target cell configuration information for SCG mobility management;
target cell configuration information for MCG and SCG mobility management;
target cell configuration information for MCG mobility management, and MCG and SCG mobility management;
target cell configuration information for SCG mobility management, and MCG and SCG mobility management; or
target cell configuration information for MCG mobility management, SCG mobility management, and MCG and SCG mobility management.

13. The method of claim 12, wherein
the target cell configuration information for MCG mobility management and the target cell configuration information for SCG mobility management are contained respectively in different messages; or
the target cell configuration information for MCG mobility management and the target cell configuration information for SCG mobility management are contained in the same message.

14. The method of claim 11, wherein the mobility management trigger event comprises at least one of:
a trigger event for MCG mobility management;
a trigger event for SCG mobility management;
a trigger event for MCG and SCG mobility management;
a trigger event for MCG mobility management, and MCG and SCG mobility management;
a trigger event for SCG mobility management, and MCG and SCG mobility management; or
a trigger event for MCG mobility management, SCG mobility management, and MCG and SCG mobility management.

15. The method of claim 14, wherein the trigger event for MCG and SCG mobility management comprises any one of:
a trigger event for assessing an MCG mobility;
a trigger event for assessing an SCG mobility; or
a plurality of trigger events for assessing an MCG mobility and for assessing an SCG mobility, respectively.

16. The method of claim 11, wherein there are one or more mobility management trigger events associated with the target cell configuration.

17. The method of claim 16, further comprising:
in response to any mobility management trigger event associated with the target cell configuration being triggered, executing the target cell configuration; or
in response to a plurality of mobility management trigger events associated with the target cell configuration being triggered, executing the target cell configuration.

18-34. (canceled)

35. A communication apparatus comprising:
a processor; and
a memory storing instructions executable by the processor,
wherein the processor is configured to:
send configuration information of condition-triggered cell management and a type of the condition-triggered cell management to a terminal device.

36. A non-transitory computer-readable storage medium for storing instructions that, when executed by one or more processors of a device, cause the device to perform the method of claim 1.

37. A communication apparatus comprising:
a processor; and
a memory storing instructions executable by the processor,
wherein the processor is configured to perform the method of claim 9.
